(19) United States
(12) Patent Application Publication
(10) Pub. No.: US 2025/0307455 A1
(43) Pub. Date: Oct. 2, 2025

(54) MACHINE LEARNING FOR CLASSIFYING INFORMATION FOR MULTI-CLOUD DEPLOYMENTS

(71) Applicant: Dell Products L.P., Round Rock, TX (US)

(72) Inventors: Shamik Kacker, Austin, TX (US); Bijan Kumar Mohanty, Austin, TX (US); Hung Dinh, Austin, TX (US)

(21) Appl. No.: 18/620,654

(22) Filed: Mar. 28, 2024

(51) Int. Cl. G06F 21/62

(52) U.S. Cl. CPC G06F 21/6245

(57) ABSTRACT

A method comprises identifying a request for data, and identifying one or more data elements that are responsive to the request for data. The one or more data elements are analyzed to classify whether the one or more data elements comprise personally identifiable information, wherein the analyzing is performed using one or more machine learning models. The method further comprises interfacing with one or more cloud platforms of a plurality of cloud platforms to transfer the one or more data elements that have been classified as comprising personally identifiable information to the one or more cloud platforms.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to using machine learning (ML) to classify personally identifiable information.

### BACKGROUND

Data privacy refers to a person's ability to determine for themselves when, how and to what extent personal information about them is shared with or communicated to others. Personally identifiable information (PII) can be, for example, one's name, location, contact information, government identification numbers, financial account numbers, etc. As organizations incorporate a mix of public, private and hybrid cloud solutions for application deployments, the management of PII on the corresponding multiple cloud platforms has become an issue of concern.

With the popularity of multi-cloud deployment models, the importance of identifying PII and ensuring compliance with PII regulations on cloud platforms has increased. For example, commercial cloud service providers offer limited to no support for compliance adherence. Instead, the cloud service providers are focused on the provisioning of infrastructure resources, paying little attention to PII protection and/or compliance. As a result, management of PII data and monitoring of PII compliance in multi-cloud environments is severely lacking.

### SUMMARY

Illustrative embodiments provide techniques to use machine learning to predict which types of information constitute PII and to interface with cloud platforms to provide the results of the predictions to the cloud platforms.

In one embodiment, a method comprises identifying a request for data, and identifying one or more data elements that are responsive to the request for data. The one or more data elements are analyzed to classify whether the one or more data elements comprise personally identifiable information, wherein the analyzing is performed using one or more machine learning models. The method further comprises interfacing with one or more cloud platforms of a plurality of cloud platforms to transfer the one or more data elements that have been classified as comprising personally identifiable information to the one or more cloud platforms.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts details of an information processing system with a PII prediction platform for predicting whether information is PII and interfacing with cloud platforms to provide the cloud platforms with identified PII, according to an illustrative embodiment.

FIG. 2 depicts an operational flow for PII prediction and interfacing with cloud platforms to provide the cloud platforms with identified PII, according to an illustrative embodiment.

FIG. 3 depicts an operational flow for PII prediction, according to an illustrative embodiment.

FIG. 4 depicts an architecture of a neural network used for PII prediction, according to an illustrative embodiment.

FIG. 5A depicts an example of a resource description framework (RDF) format for a relationship graph, according to an illustrative embodiment.

FIG. 5B depicts an example of a labeled property graph (LPG) format for a relationship graph, according to an illustrative embodiment.

FIGS. 6A and 6B depict example pseudocode for interfacing with a first cloud provider platform to provide the first cloud provider platform with identified PII, according to an illustrative embodiment.

FIGS. 7A and 7B depict example pseudocode for interfacing with a second cloud provider platform to provide the second cloud provider platform with identified PII, according to an illustrative embodiment.

FIGS. 8A and 8B depict example pseudocode for interfacing with a third cloud provider platform to provide the third cloud provider platform with identified PII, according to an illustrative embodiment.

FIG. 9 depicts a process for PII prediction and cloud platform interfacing, according to an illustrative embodiment.

FIGS. 10 and 11 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous, and a user device receives messages without any significant time delay. Of course, it should be understood that depending on the particular temporal nature of the system in which an embodiment is implemented, other appropriate timescales that provide at least contemporaneous performance and output can be achieved.

As used herein, “personally identifiable information (PII)” refers to any information that can be used to distinguish or trace an individual's identity, such as, but not necessarily limited to, name, social security number, date and place of birth, mother's maiden name and/or biometric records, and any other information that is linked or linkable to an individual, such as, but not necessarily limited to, medical, educational, financial and/or employment information. See National Institute of Standards and Technology (NIST) Special Publication 800-122 (2010). Some other non-limiting examples of PII include, but are not necessarily limited to, financial transactions, medical history, criminal history, employment history, aliases, residential and mailing addresses, IP addresses, email addresses, online identifiers, passport number, driver's license number, telephone numbers, credit card numbers, vehicle registrations, x-rays, patient ID numbers, and biometric data (e.g., retina scan, voice signature, facial geometry, etc.).

There have been global, national and local treaties, legislation, regulations and/or other initiatives to protect PII. In general, the initiatives state that data corresponding to PII should be processed in a lawful, fair and transparent manner, be collected for specified, explicit and legitimate purposes, be adequate, relevant and limited to what is necessary in relation to the purpose for which the data is being processed (data minimization), be accurate, be maintained no longer than necessary and be processed in a manner that ensures appropriate security. Organizations may face significant penalties if they are not compliant with data privacy laws.

Illustrative embodiments provide technical solutions for the identification of PII data. Advantageously, the embodiments utilize a security framework to centralize all PII data in a repository by identifying the PII using machine learning techniques and then applying the identified PII across various applications deployed across multiple cloud provider platforms (e.g., multi-cloud environment) for monitoring and enforcement of policies. The PII data is identified by utilizing historical PII data elements (e.g., previously identified PII data elements in an enterprise) and by leveraging a neural network-based classifier to identify PII data elements in applications and databases at a schema level. By building relationships between PII data elements and managing the relationships in a repository in graph form, this content can be queried for governance and enforcement across applications deployed in a multi-cloud environment and other security tasks including compliance with the General Data Protection Regulation (GDPR). As an additional advantage, the illustrative embodiments leverage one or more machine learning models to identify in real-time responsive to a request for data whether the data comprises PII and apply necessary protections and/or controls to safeguard the PII data across a multi-cloud environment. As noted above, PII data and metadata is stored in a centralized repository where attributes represented by the data, metadata and their relationships can be maintained and queried.

In one or more embodiments, historical PII data is used to train a neural network-based machine learning classifier to identify whether requested data includes PII. Requests for data may include, for example, database requests, cache system requests, application programming interface (API) requests, messaging system requests and streaming system requests. The embodiments leverage various enterprise data and/or metadata sources to identify PII data. The machine learning algorithms described herein enable accurate classification of PII data, making efficient use of compute resources and accelerating privacy operations at scale.

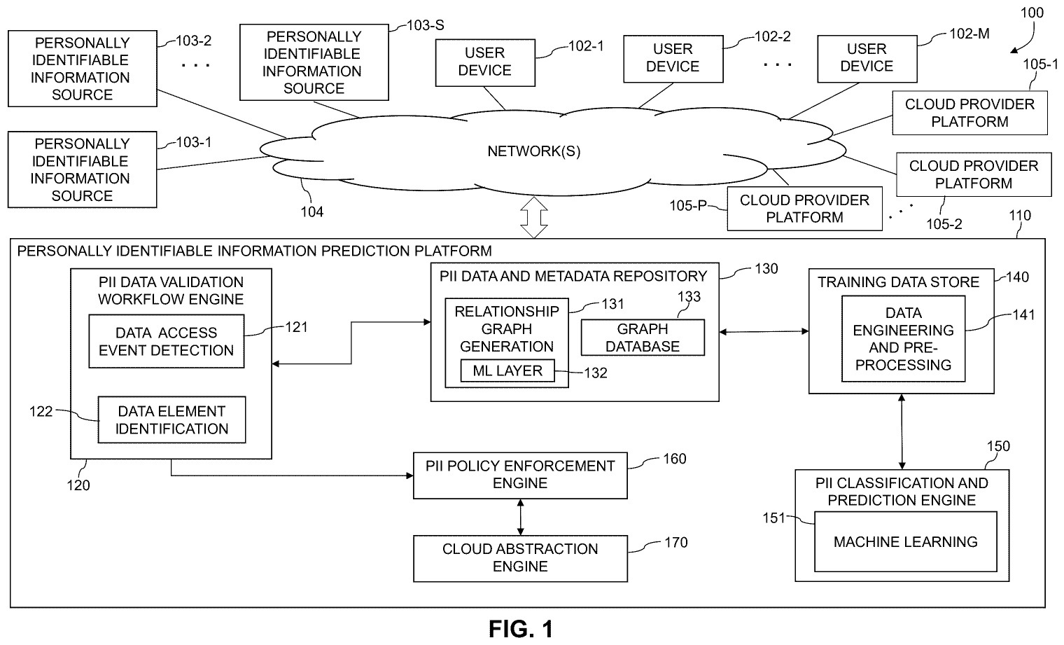

FIG. 1 shows an information processing system 100 configured in accordance with an illustrative embodiment. The information processing system 100 comprises user devices 102-1, 102-2, . . . 102-M (collectively “user devices 102”) and cloud provider platforms 105-1, 105-2, . . . 105-P (collectively “cloud provider platforms 105”). The user devices 102 and cloud provider platforms 105 communicate over a network 104 with a PII prediction platform 110.

The user devices 102 and one or more devices of the cloud provider platforms 105 can comprise, for example, Internet of Things (IoT) devices, desktop, laptop or tablet computers, mobile telephones, or other types of processing devices capable of communicating with the PII prediction platform 110 over the network 104. Such devices are examples of what are more generally referred to herein as “processing devices.” Some of these processing devices are also generally referred to herein as “computers.” The user devices 102 and one or more devices of the cloud provider platforms 105 may also or alternately comprise virtualized computing resources, such as virtual machines (VMs), containers, etc. The user devices 102 and one or more devices of the cloud provider platforms 105 in some embodiments comprise respective computers associated with a particular company, organization or other enterprise. The variable M and other similar index variables herein such as K, L, S and P are assumed to be arbitrary positive integers greater than or equal to one.

The terms “client,” “customer” or “user” herein are intended to be broadly construed so as to encompass numerous arrangements of human, hardware, software or firmware entities, as well as combinations of such entities. PII prediction services may be provided for users utilizing one or more machine learning models, although it is to be appreciated that other types of infrastructure arrangements could be used. At least a portion of the available services and functionalities provided by the PII prediction platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the PII prediction platform 110, as well as to support communication between the PII prediction platform 110 and connected devices (e.g., user devices 102) and/or other related systems and devices not explicitly shown.

In some embodiments, the user devices 102 are assumed to be associated with repair technicians, system administrators, information technology (IT) managers, software developers, release management personnel or other authorized personnel configured to access and utilize the PII prediction platform 110. The user devices 102 can also be respectively associated with one or more customers requiring the services of one or more cloud providers. Some non-limiting examples of cloud providers that may correspond to the cloud provider platforms 105 include, but are not necessarily limited to, Amazon® Web Services (AWS®), Azure®, Google® Cloud Platform (GCP®) and/or Oracle® cloud providers.

The PII prediction platform 110 in the present embodiment is assumed to be accessible to the user devices 102 and/or cloud provider platforms 105, and vice-versa, over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The PII prediction platform 110, on behalf of respective infrastructure tenants each corresponding to one or more users associated with respective ones of the user devices 102, provides a platform for predicting whether information is PII.

Referring to FIG. 1, the PII prediction platform 110 comprises a PII data validation workflow engine 120, a PII data and metadata repository 130, a training data store 140, a PII classification and prediction engine 150, a PII policy enforcement engine 160 and a cloud abstraction engine 170. The PII data validation workflow engine 120 comprises a data access event detection component 121 and a data element identification component 122. The PII data and metadata repository 130 comprises a relationship graph generation component 131 comprising a machine learning (ML) layer 132, and a graph database 133. The training data store 140 comprises a data engineering and data pre-processing component 141. The PII classification and prediction engine 150 comprises a machine learning (ML) layer 151.

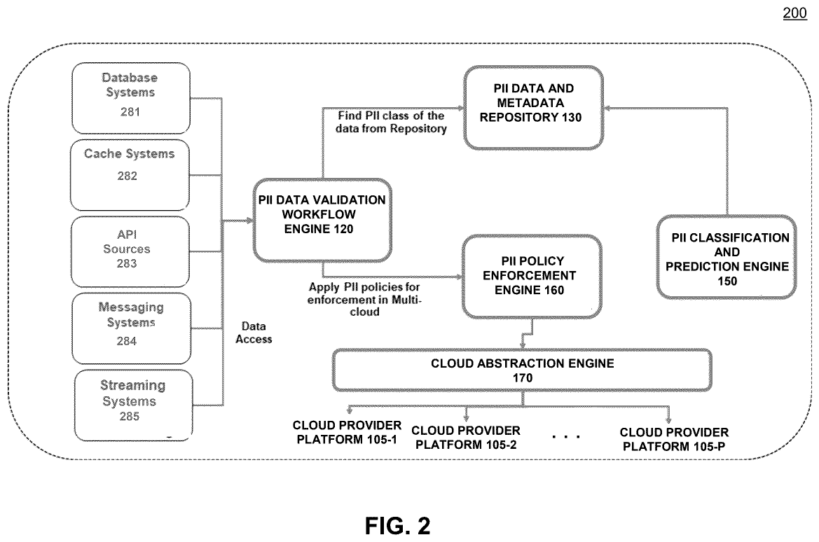

The data access event detection component 121 of the PII data validation workflow engine 120 detects and identifies requests for data (e.g., requests to access data) received over network 104 from, for example, one or more user devices 102. The requests may be issued to and received by one or more PII sources 103-1, 103-2, . . . , 103-P (collectively “PII sources 103”). Referring to the operational flow 200 in FIG. 2, in a non-limiting illustrative embodiment, requests for data can be generated through one or more user devices 102 (e.g., data and messaging access generated from various applications) to PII sources 103 such as, for example, database systems 281, cache systems 282, API sources 283, messaging systems 284, and streaming systems 285. The requested data may include multiple types of data elements that can potentially have PII data. Before the data is accessed and returned, the PII prediction platform 110 identifies if any of the data being requested contains data elements that include PII. In illustrative embodiments, the PII sources 103 trigger the data access event detection component 121 of the PII data validation workflow engine 120 to detect requests for data at a given one of the PII sources 103. Alternatively, the data access event detection component 121 monitors the PII sources for data access events.

In illustrative embodiments, the PII sources 103 comprise one or more databases and/or applications including data elements that may comprise PII. Upon occurrence of a request for data from the PII sources 103 (e.g., database systems 281, cache systems 282, API sources 283, messaging systems 284, and streaming systems 285), the data access event detection component 121 receives an event message from one of the PII sources 103 comprising the requested data, whereby the data element identification component 122 identifies one or more data elements in the requested data. The data elements include, but are not necessarily limited to, a representation of the storage of data in a database, data describing the organization or structure of data and the relationships between tables in a given database, formats for data entries, unique keys for entries and database objects, and the name and data type for each column and/or row in a table. Some other examples of data elements include, but are not necessarily limited to, customer or user information (e.g., name, address, IDs, financial information, family information, employment information, governmental identification numbers, medical information, etc.), transaction information (e.g., customer IDs, transaction dates, etc.), passwords, and product information (e.g., products names, prices, etc.).

The PII data validation workflow engine 120 provides an interface layer for communications with the PII sources 103. Inbound or outbound communications involving multiple types of messages, pass through the PII data validation workflow engine 120 before and after being processed by the PII prediction platform 110. The PII data validation workflow engine 120 also functions as an interface between and a communications hub for the various engines of the PII prediction platform 110. For example, once the data element identification component 122 identifies the data elements in the requested data, the PII data validation workflow engine 120 sends the data elements to the PII data and metadata repository 130 along with a request to classify whether the data elements comprise PII data. This request is forwarded to the PII classification and prediction engine 150. In more detail, the PII classification and prediction engine 150 uses a deep neural network-based classifier and enterprise specific domain data as training data to classify and predict whether data elements comprise PII. Once PII data elements are identified, the PII data validation workflow engine 120 calls the PII policy enforcement engine 160 to predict a type of policy needed to apply to a given data element comprising PII. In illustrative embodiments, the PII policy enforcement engine 160 uses a deep neural network and historical policy run-time data to predict the most appropriate policy to be applied for that specific PII data. Once a PII policy is identified, the PII policy enforcement engine 160, through the cloud abstraction engine 170 provides the PII data and policy to one or more of the cloud platforms so that the cloud provider platforms 105 can implement appropriate PII compliance policies on the data in a cloud environment before the data is returned to a user or other data requesting entity (e.g., application).

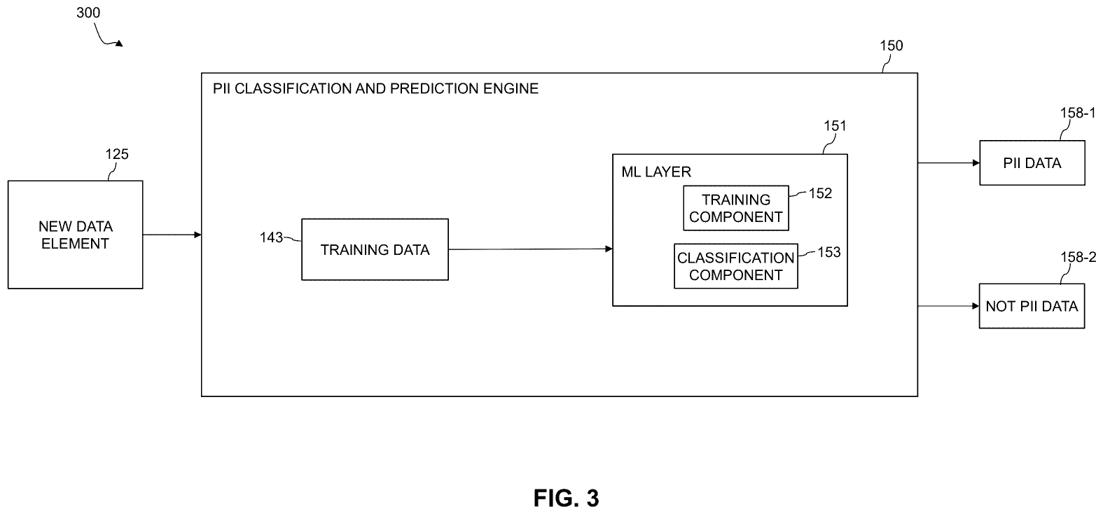

Referring to FIG. 1 and to the operational flow 300 in FIG. 3, the PII classification and prediction engine 150 includes a training component 152 and a classification component 153 in ML layer 151, which identifies whether a data element comprises PII data by leveraging a neural network-based classification algorithm as a binary classifier to predict the class (e.g., PII data 158-1 or not PII data 158-2). The training component 152 utilizes existing PII data from the training data store 140 as training data 143. The training data 143 is input to the training component 152 of the ML layer 151 to train the machine learning model.

The training data store 140 includes historical data (e.g., historical enterprise data and/or historical data from other sources) with information such as whether a data element is PII. The PII classification and prediction engine 150, more particularly, the training component 152, leverages supervised learning mechanisms, whereby the model is trained with the historical data labelled with an indicator of whether data elements constitute PII. Some of the features that influence the target variables (e.g., PII data or not PII data) and which are extracted from the training dataset include, for example, element name, parent element(s), related element(s) and attributes. During the training, these features are fed into the model as independent variables and the values of the class (data element is PII or not PII) are fed into the model as the dependent/target values. On receiving a new data element 125, the trained classifier-based model is used to predict if the new data element is PII data 158-1 or not PII data 158-2.

Referring to FIG. 1, the training data store 140 includes a data engineering and data pre-processing component 141, which according to an embodiment, performs data engineering and data pre-processing to identify the features and the data elements that will be influencing the PII data predictions. In illustrative embodiments, the data engineering and data pre-processing includes generating multivariate plots and correlation heatmaps to identify the significance of each feature in a training dataset, and filter less important data elements. The data engineering and data pre-processing reduces the dimensions and complexity of the model, hence improving the accuracy and performance of the model. In some embodiments, the data engineering and data pre-processing component 141 cleans any unwanted characters and stop words from the training data, and may perform stemming and lemmatization, as well as changing text to lower case, removing punctuation, and removing incorrect or unnecessary characters. Once the data is ready to be used as training data 143, the training data 143 is input to the training component 152 of the ML layer 151.

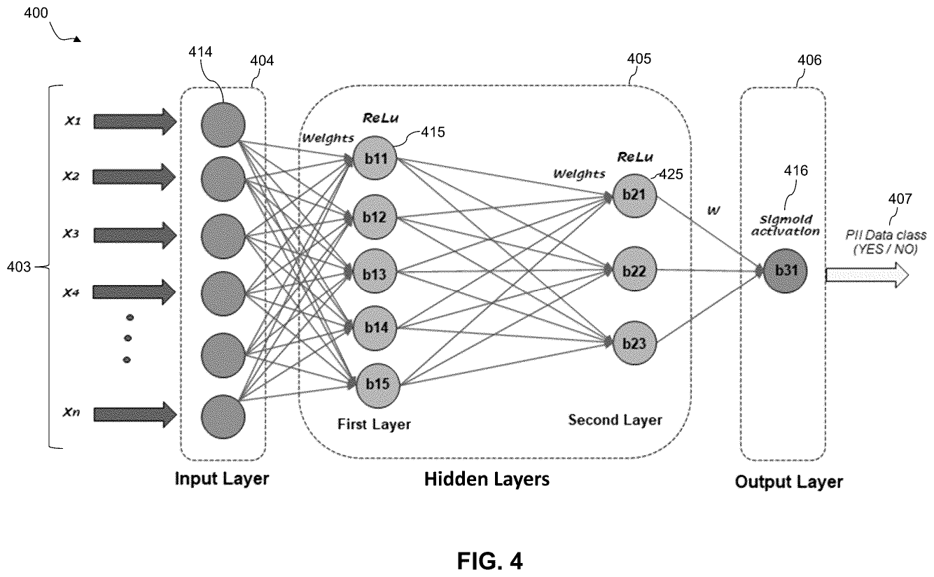

Referring to FIG. 4, data element features 403 from the PII data validation workflow engine 120 are input to an input layer 404 of neural network 400 comprising at least two hidden layers 405 (e.g., first and second layers) and an output layer 406. The data element features include, for example, as noted above, element name, parent element(s), related element(s) and attributes such as, but not necessarily limited to, customer or user information, transaction information, passwords, product information, storage representations, data describing the organization or structure of data, relationships between tables in a given database, formats for data entries, unique keys for entries and database objects, and the name and data type for each column and/or row in a table. In general, the data element features 403 include, but are not necessarily limited to, features or elements added to database systems 281, cache systems 282, API sources 283, messaging systems 284 or streaming systems 285 that may include one or more of the types of the PII described herein. The neural network 400 is an element of the classification component 153, which predicts whether a data element comprises PII data.

During the training, the features noted herein above (e.g., data element features 403) are input to the neural network (or other machine learning model) as independent variables with the values of the class (data element is PII or not PII) in the dataset as dependent (e.g., target values). Once trained, the machine learning model predicts the values of the class (attribute is PII or not PII).

Referring to FIG. 4, the neural network 400 comprises, for example, a deep neural network comprising an input layer 404, one or more hidden layers 405 and an output layer 406. Input layer 404 comprises a plurality of neurons 414 (nodes) that matches the number of input independent variables (e.g., features). Hidden layers 405 comprise first and second layers. The number of neurons 415 and 425 in each of the first and second layers depend on the number of neurons 414 in the input layer 404. As the machine learning model is a binary classification model, the output layer 406 includes a single neuron 416 corresponding to a YES or NO output 407 (YES-PII data, NO-not PII data).

Although there are five neurons 415 shown in the first layer of the hidden layers 405 and three neurons 425 shown in the second layer of the hidden layers 405, the actual number of neurons 415 and 425 depend on the total number of neurons 414 in the input layer 404. For example, the number of neurons 415 in the first layer is calculated based on an algorithm matching the power of 2 to the number of input neurons 414. For example, in a non-limiting illustrative example, if the number of input variables is 19, the number of neurons in the first layer of the hidden layers 405 is 2⁵, which is equal to 32. 2⁴, which is equal to 16, is too small (e.g., less than 19). As a result, the first layer of the hidden layers 405 will have 2⁵=32 neurons, and the second layer of the hidden layers 405 will include 2⁴=16 neurons. If there were a third hidden layer, it would include 2³=8 neurons. The embodiments are not necessarily limited to basing the number of neurons 415 and 425 in the hidden layers 405 on the number of neurons 414 in the input layer 404, and other methods to determine the number of neurons 415 and 425 may be used.

According to illustrative embodiments, the neurons 415 and 425 in the hidden layers 405 and the neuron 416 in the output layer 406 utilize an activation function which determines whether the neuron will fire or not fire. For example, rectified linear unit (ReLu) activation function is used for the neurons 415 and 425 in both the first and second ones of the hidden layers 405. Considering the model is configured to function as a binary classifier, the output neuron 416 in the output layer 406 utilizes a Sigmoid activation function. The embodiments are not necessarily limited to the ReLu and Sigmoid activation functions.

In the illustrative embodiment of FIG. 4, each of the neurons 414 connects with each of the neurons 415, each of the neurons 415 connects with each of the neurons 425 and each of the neurons 425 connects with the neuron 416. Each connection has a weight factor and each of the neurons 415, 425 and 416 has a bias factor. In an illustrative embodiment, the weight and bias values may be randomly set by the neural network 400, and may start at values of 1 or 0. In illustrative embodiments, each neuron 415 computes a weighted sum (WS) by adding the products of each input variable (X1, X2, X3, X4, . . . , Xn) with their weight factors and then adding the bias of the neuron 415. The formula for this calculation is shown as equation (1) below.

$$WSz = ( X 1 ) ( W 1 z ) + ( X 2 ) ( W 2 z ) + ( X 3 ) ( W 3 z ) + ( X 4 ) ( W 4 z ) , \\ … , ( Xn ) ( Wnz ) + b 1 z \qquad ( 1 )$$

where WSz is the weighted sum of neuron Z, where Z is from 1 (for the 1^{st} neuron 415) to the number of neurons 415 in the first layer of the hidden layers 405. X1, X2, etc. are the input values to the model and W1z, W2z, etc. are the weight values applied to the connections to the neuron Z from the input neurons 414 and b1z is the bias value of neuron Z. This weighted sum WSz is input to an activation function (e.g., in this case ReLu) to compute the value of the activation function for each neuron 415. The weighted sum values of all neurons 415 in the first layer are calculated in accordance with equation (1).

In illustrative embodiments, each neuron 425 computes a next weighted sum (NWS) by adding the products of each weighted sum from the neurons 415 (WS1, WS2, WS3, WS4, . . . , WSz) with their weight factors and then adding the bias of the neuron 425. The formula for this calculation is shown as equation (2) below.

$$NWSy = ( WS 1 ) ( W 1 y ) + ( WS 2 ) ( W 2 y ) + ( WS 3 ) ( W 3 y ) + ( WS 4 ) ( W 4 y ) , \\ … , ( WSz ) ( Wzy ) + b 2 y \qquad ( 2 )$$

where NWSy is the weighted sum of neuron Y, where Y is from 1 (for the 1^{st} neuron 425) to the number of neurons 425 in the second layer of the hidden layers 405. WS1, WS2, etc. are the weighted sums from the neurons 415 and W1y, W2y, etc. are the weight values applied to the connections to the neuron Y from the neurons 415 and b2y is the bias value of neuron Y. This next weighted sum NWSy is input to an activation function (e.g., in this case ReLu) to compute the value of the activation function for each neuron 425. The next weighted sum values of all neurons 425 in the second layer are calculated in accordance with equation (2).

In illustrative embodiments, the neuron 416 computes a final weighted sum (FWS) by adding the products of each next weighted sum from the neurons 425 (NWS1, NWS2, . . . , NWSy) with their weight factors and then adding the bias of the neuron 416. The formula for this calculation is shown as equation (3) below.

$$FWS = ( NWS 1 ) ( W 1 ) + ( NWS 2 ) ( W 2 ) , … , ( NWSy ) ( Wy ) + b 3 \qquad ( 3 )$$

where FWS is the weighted sum of neuron 416 in the output layer 406. NWS1, NWS2, etc. are the next weighted sums from the neurons 425 and W1, W2, etc. are the weight values applied to the connections to the neuron 416 from the neurons 425 and b3 is the bias value of neuron 416. This final weighted sum FWS is input to an activation function (e.g., in this case Sigmoid) to compute the value of the activation function for the neuron 416. The final weighted sum value of neuron 416 in the output layer 406 is calculated in accordance with equation (3).

The final weighted sum value is compared to a target value. Depending upon the difference from the target value, a loss value is calculated. The pass through of the neural network 400 is a forward propagation, which calculates error and drives a backpropagation through the neural network 400 to minimize the loss (e.g., error) at each neuron 414, 415, 425 and 416 of the neural network 400. Considering loss may be generated by all the neurons 414, 415, 425 and 416 in the neural network 400, a backpropagation process goes through each layer from the output layer 406 to the input layer 404 and attempts to minimize the loss by using a gradient descent-based optimization mechanism. Considering the neural network 400 is used in illustrative embodiments as a binary classifier, illustrative embodiments use “binary_crossentropy” as a loss function, adam (adaptive moment estimation) or “RMSProp” as an optimization algorithm, and “accuracy” as a metrics value.

The result of the backpropagation processing is to adjust the weight and/or bias values corresponding to one or more connections and/or neurons 414, 415, 425 and 416 in order to reduce loss. Once all the observations of the training data are passed through the neural network 400, an epoch is completed. Another forward propagation is initiated with the adjusted weight and bias values, which is considered as epoch2. The same process of forward and backpropagation is repeated in subsequent epochs. This process of repeating the epochs results in the reduction of loss to a relatively small number (e.g., close to 0), at which point the neural network 400 is considered to be sufficiently trained for prediction.

Once PII classification is successfully performed on a new data element, the classification is stored in the PII data and metadata repository 130 along with the relationships and other elements and/or attributes for governance and queries. The PII data and metadata repository 130 stores and manages PII data elements and their relationships to other elements in a central manner for scalability, high performance and fast access to the data. The other elements may include, for example, other attributes that include PII or do not include PII. For example, the PII data and metadata repository 130 can store related PII, such as different types of PII for the same person, or PII related by category (e.g., medical PII, financial PII, etc.). In addition, PII data may be related to other data that is not PII. For example, customers and their PII may be associated with particular order, marketing or supply chain information that is not PII. In one or more illustrative embodiments, a graph database is leveraged to manage PII data elements and their relationships. In other embodiments, a no-SQL database can be used.

The PII data and metadata repository 130 comprises a relationship graph generation component 131, which includes an ML layer 132 that uses one or more machine learning techniques to build relationship graphs corresponding to PII data elements and their relationships to other elements. The PII data and metadata repository 130 stores the relationship graphs in a graph database 133 to provide a knowledge base of PII for an enterprise or other entity.

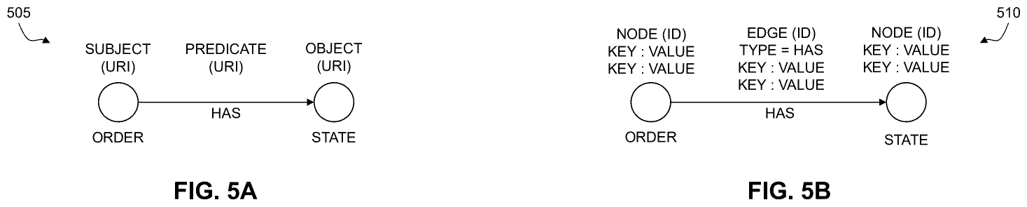

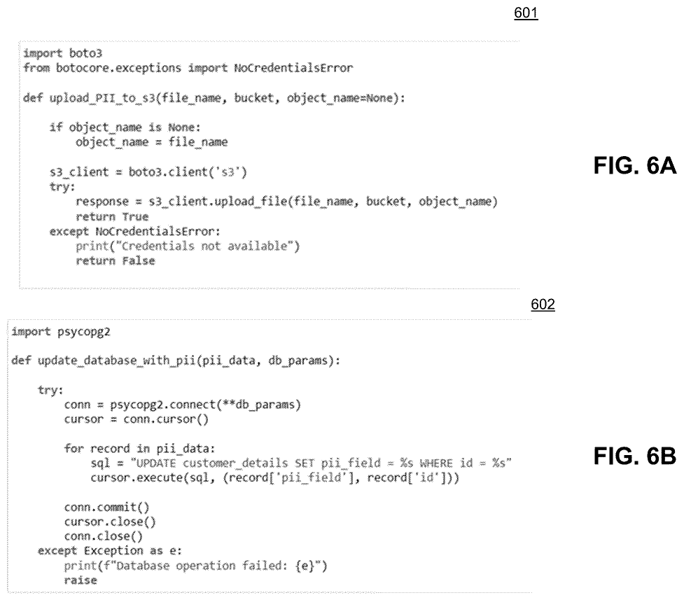

Referring to FIGS. 5A and 5B, examples of a resource description framework (RDF) format 505 and a labeled property graph (LPG) format 510 for a relationship graph are shown. In accordance with embodiments, the RDF format or the LPG format can be used for storing information on and retrieving information from relationship graphs. The examples of the RDF and LPG formats are explained in terms of an order having a state, but the embodiments are not limited thereto.

The RDF format 505 structures information (e.g., entities and relationship) as a triple comprising a subject, predicate and object. For example, an order that has a state is stored as a subject (order), the predicate is the relationship (e.g., has) and the object is the other entity (e.g., state). As can be seen, the subject is a node/entity in the graph. The predicate is an edge (e.g., relationship between nodes), and the object is another node. These nodes and edges are identified by unique resource identifiers (URIs), which are used to label the nodes and edges.

With the LPG format 510, each entity is represented as a node with a uniquely identifiable ID and a set of key-value pairs corresponding to properties that characterize the entity (e.g., in this case key-value pairs that identify the order and the attribute (state)). The relationship between two entities comprises an edge, which is a connection between the nodes. Relationships are uniquely identified by a uniquely identifiable ID and a type (e.g., has). Relationships are also represented by a set of key-value pairs corresponding to properties that characterize the connections. While two key-value pairs are shown as corresponding to each entity and relationship, the embodiments are not necessarily limited thereto, and more or less than two key-value pairs may be used to identify and characterize the nodes and edges.

According to one or more embodiments, the PII data and metadata repository 130 stores relationship graphs in the graph database 133 and provides relationship data from the relationship graphs in response to queries or other inputs. The graphical format permits data analysis and traversal at multiple levels in real-time and enables the real-time addition of new context and connections. Advantageously, the graph-based PII data and metadata repository 130 provides a foundation for maintaining data of an enterprise, which accelerates the growth and sustenance of long-term knowledge. The PII data and metadata repository 130 is capable of being enriched with raw and derived data over time, resulting in graphs that include increasing levels of details, context, truth, intelligence, and semantics. The graphical format is more indicative of a user's real-world ecosystem and domain than other representations of data, and provides a more efficient mechanism for search and retrieval of information than other approaches. Data can be retrieved from the PII data and metadata repository 130 using a variety of query languages capable of traversing graphs such as, but not necessarily limited to, formats including structured query language (SQL) and

SPARQL. Some non-limiting examples of graph traversal languages that may be used with the PII data and metadata repository 130 include Gremlin, Cypher, GraphQL and/or Graphene. GraphQL and Graphene are languages for APIs to access the data in the graph database 133.

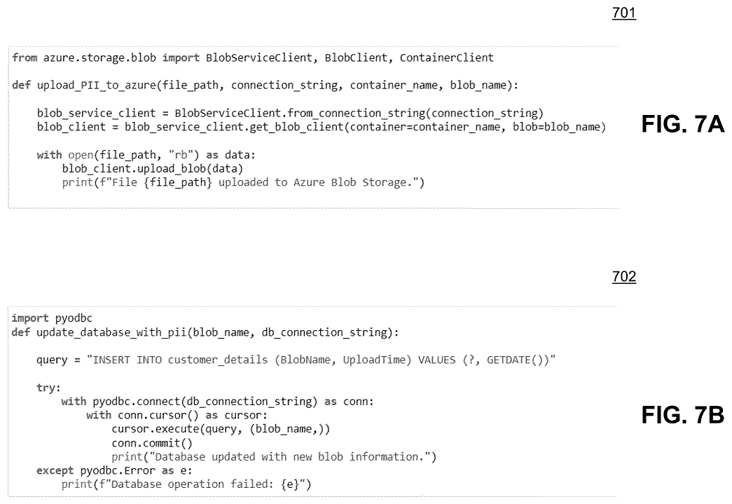

As applications (e.g., applications in an enterprise) are increasingly hosted in a multitude of cloud environments, the PII prediction platform 110 includes the PII policy enforcement engine 160 and the cloud abstraction engine 170 to cause updating of corresponding cloud provider platforms 105 once new PII data elements are identified. As policy enforcement in various cloud environments (e.g., various cloud provider platforms 105) differ and the managed services for handling the enforcement differ from one vendor to another, the cloud abstraction engine 170 creates an abstraction layer to hide the implementation complexities of interfacing with various cloud providers from an end user. While a request for transmitting enforcement updates to multiple cloud provider platforms 105 can be sent to the cloud abstraction engine 170 from the PII policy enforcement engine 160 in a standard manner, respective requests to the respective ones of the cloud provider platforms 105 from cloud abstraction engine 170 must be sent according to the requirements of the specific cloud provider. For example, an application deployed on the AWS® cloud platform requires multiple steps to transfer data elements that have been classified as comprising PII to that particular cloud platform provider. For example, referring to the pseudocode 601 and 602 in FIGS. 6A and 6B, interfacing with the AWS® cloud platform to transfer data elements that have been classified as comprising PII to the AWS® cloud platform comprises: (i) using a designated client library (e.g., boto3) to upload the data elements that have been classified as comprising PII to a cloud platform bucket (e.g., S3 bucket); and (ii) using a designated AWS® cloud platform API and/or a designated database adapter (e.g., psycopg2) corresponding to a database of the AWS® cloud platform (e.g., PostgreSQL database) to download the data elements that have been classified as comprising PII from the cloud platform bucket to the database. In more detail, first the PII data element needs to be updated to the s3 bucket and then all pertaining databases for the applications need to be updated. Referring to the pseudocode 601 and 602 in FIGS. 6A and 6B, this can be achieved by first using boto3 client library and then using AWS® cloud platform specific APIs or a psycopg2 connector if the database is a PostgreSQL.

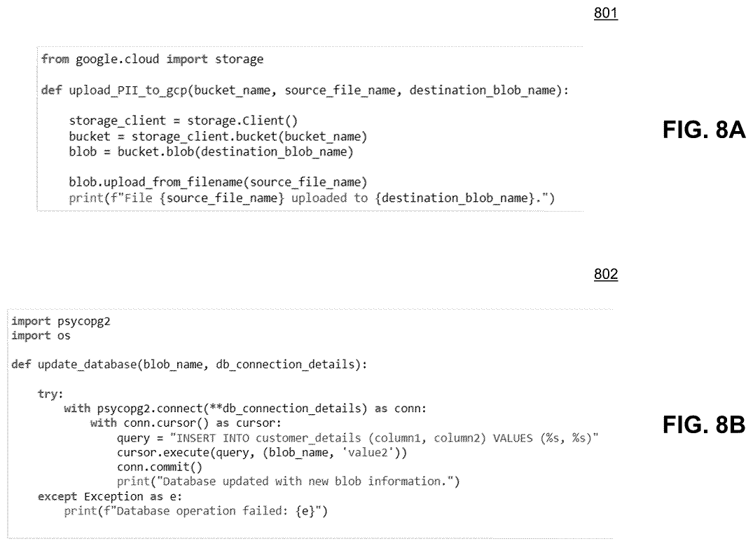

Referring to the pseudocode 701 and 702 in FIGS. 7A and 7B, interfacing with the Azure® cloud platform to transfer data elements that have been classified as comprising PII to the Azure® cloud platform comprises: (i) uploading the data elements that have been classified as comprising PII to cloud object (e.g., binary large object (blob)) storage for the Azure® cloud platform; and (ii) downloading the data elements that have been classified as comprising PII from the cloud object storage to a database of the Azure® cloud platform. In more detail, the PII data element is uploaded to Azure® blob storage and downloaded from the Azure® blob storage to an Azure® database.

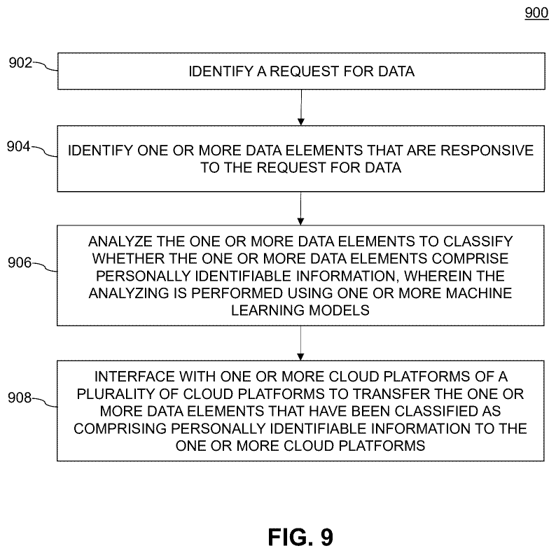

Referring to the pseudocode 801 and 802 in FIGS. 8A and 8B, interfacing with the GCP® to transfer data elements that have been classified as comprising PII to the GCP® comprises: (i) uploading the data elements that have been classified as comprising PII to Google® cloud storage for the GCP®; and (ii) downloading the data elements that have been classified as comprising PII from the cloud storage to a database of the GCP®. In more detail, the PII data element is uploaded to Google® cloud storage and downloaded from the Google® cloud storage to a Google® PostgreSQL database.

Given a particular data access event, the PII classification and prediction engine 150 uses one or more machine learning techniques to identify secure and private data in real-time at the time of a request for data. Leveraging a sophisticated binary classification machine learning model to predict whether data elements comprise PII as a real-time response to a request for data, the embodiments support the efficient implementation of security and governance measures for the corresponding PII data. In illustrative embodiments, the PII prediction platform 110 further performs other automated actions based on the classification including, but not necessarily limited to, automatically interfacing with and updating multiple cloud platforms with identified PII data.

According to one or more embodiments, one or more of the databases (e.g., graph database 133, training data store 140) and/or repositories (e.g., PII data and metadata repository 130) used by the PII prediction platform 110 and/or cloud platform databases, can be configured according to a relational database management system (RDBMS) (e.g., PostgreSQL). Databases and/or repositories in some embodiments are implemented using one or more storage systems or devices associated with the PII prediction platform 110. In some embodiments, one or more of the storage systems utilized to implement the databases comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the PII prediction platform 110, the PII data validation workflow engine 120, PII data and metadata repository 130, training data store 140, PII classification and prediction engine 150, PII policy enforcement engine 160 and cloud abstraction engine 170 in other embodiments can be implemented at least in part externally to the PII prediction platform 110, for example, as stand-alone servers, sets of servers or other types of systems coupled to the network 104. For example, the PII data validation workflow engine 120, PII data and metadata repository 130, training data store 140, PII classification and prediction engine 150, PII policy enforcement engine 160 and cloud abstraction engine 170 may be provided as cloud services accessible by the PII prediction platform 110.

The PII data validation workflow engine 120, PII data and metadata repository 130, training data store 140, PII classification and prediction engine 150, PII policy enforcement engine 160 and cloud abstraction engine 170 in the FIG. 1 embodiment are each assumed to be implemented using at least one processing device. Each such processing device generally comprises at least one processor and an associated memory, and implements one or more functional modules for controlling certain features of the PII data validation workflow engine 120, PII data and metadata repository 130, training data store 140, PII classification and prediction engine 150, PII policy enforcement engine 160 and/or cloud abstraction engine 170.

At least portions of the PII prediction platform 110 and the components thereof may be implemented at least in part in the form of software that is stored in memory and executed by a processor. The PII prediction platform 110 and the components thereof comprise further hardware and software required for running the PII prediction platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the PII data validation workflow engine 120, PII data and metadata repository 130, training data store 140, PII classification and prediction engine 150, PII policy enforcement engine 160, cloud abstraction engine 170 and other components of the PII prediction platform 110 in the present embodiment are shown as part of the PII prediction platform 110, at least a portion of the PII data validation workflow engine 120, PII data and metadata repository 130, training data store 140, PII classification and prediction engine 150, PII policy enforcement engine 160, cloud abstraction engine 170 and other components of the PII prediction platform 110 in other embodiments may be implemented on one or more other processing platforms that are accessible to the PII prediction platform 110 over one or more networks. Such components can each be implemented at least in part within another system element or at least in part utilizing one or more stand-alone components coupled to the network 104.

It is assumed that the PII prediction platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the PII data validation workflow engine 120, PII data and metadata repository 130, training data store 140, PII classification and prediction engine 150, PII policy enforcement engine 160, cloud abstraction engine 170 and other components of the PII prediction platform 110, and the elements thereof can each be implemented in the form of one or more LXCs running on one or more VMs. Other arrangements of one or more processing devices of a processing platform can be used to implement the PII data validation workflow engine 120, PII data and metadata repository 130, training data store 140, PII classification and prediction engine 150, PII policy enforcement engine 160 and cloud abstraction engine 170, as well as other components of the PII prediction platform 110. Other portions of the system 100 can similarly be implemented using one or more processing devices of at least one processing platform.

Distributed implementations of the system 100 are possible, in which certain components of the system reside in one datacenter in a first geographic location while other components of the system reside in one or more other data centers in one or more other geographic locations that are potentially remote from the first geographic location. Thus, it is possible in some implementations of the system 100 for different portions of the PII prediction platform 110 to reside in different data centers. Numerous other distributed implementations of the PII prediction platform 110 are possible.

Accordingly, one or each of the PII data validation workflow engine 120, PII data and metadata repository 130, training data store 140, PII classification and prediction engine 150, PII policy enforcement engine 160, cloud abstraction engine 170 and other components of the PII prediction platform 110 can each be implemented in a distributed manner so as to comprise a plurality of distributed components implemented on respective ones of a plurality of compute nodes of the PII prediction platform 110.

It is to be appreciated that these and other features of illustrative embodiments are presented by way of example only and should not be construed as limiting in any way.

Accordingly, different numbers, types and arrangements of system components such as the PII data validation workflow engine 120, PII data and metadata repository 130, training data store 140, PII classification and prediction engine 150, PII policy enforcement engine 160, cloud abstraction engine 170 and other components of the PII prediction platform 110, and the elements thereof can be used in other embodiments.

It should be understood that the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

For example, as indicated previously, in some illustrative embodiments, functionality for the PII prediction platform can be offered to cloud infrastructure customers or other users as part of FaaS, CaaS and/or PaaS offerings.

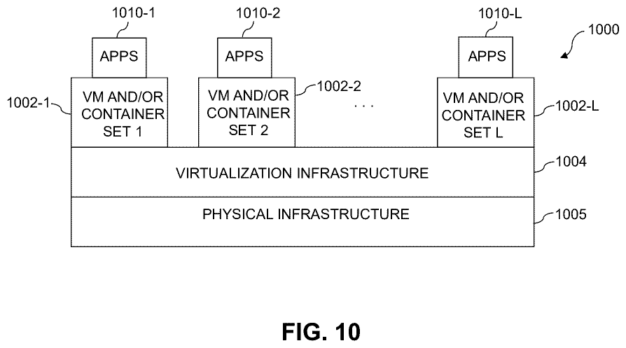

The operation of the information processing system 100 will now be described in further detail with reference to the flow diagram of FIG. 9. With reference to FIG. 9, a process 900 for predicting whether information is PII and interfacing with cloud platforms to provide the cloud platforms with identified PII as shown includes steps 902 through 908, and is suitable for use in the system 100 but is more generally applicable to other types of information processing systems comprising a PII prediction platform configured for PII prediction and cloud platform interfacing.

In step 902, a request for data is identified. In an illustrative embodiment, the request for data comprises one of a database request, a cache system request, an application programming interface request, a messaging system request and a streaming system request.

In step 904, one or more data elements that are responsive to the request for data are identified.

In step 906, the one or more data elements are analyzed to classify whether the one or more data elements comprise PII, wherein the analyzing is performed using one or more machine learning models. The analyzing can be performed in real-time responsive to the request for data.

In step 908, one or more cloud platforms of a plurality of cloud platforms are interfaced with to transfer the one or more data elements that have been classified as comprising PII to the one or more cloud platforms.

The one or more machine learning models may comprise a neural network-based binary classification algorithm to classify whether the one or more data elements comprise PII. In illustrative embodiments, a neural network of the neural network-based binary classification algorithm is trained with training data comprising a plurality of data elements as independent variables, wherein respective ones of the plurality of data elements correspond to respective dependent variables indicating whether the respective ones of the plurality of data elements comprise PII. A neural network of the neural network-based binary classification algorithm can comprise at least two hidden layers utilizing a ReLu activation function, and can comprise a plurality of nodes connected with each other, wherein respective ones of the connections comprise a weight factor and respective ones of the plurality of nodes comprise a bias factor.

The process may include storing, in one or more relationship graphs, the one or more data elements that have been classified as comprising PII. In illustrative embodiments, the one or more relationship graphs comprise a plurality of relationships between a plurality of nodes, wherein the plurality of relationships comprise edges of the one or more relationship graphs. The plurality of nodes may comprise the one or more data elements that have been classified as comprising PII and one or more other data elements. The plurality of relationships may comprise interactions between respective pairs of the plurality of nodes, and the one or more relationship graphs may be in one of an RDF format and an LPG format.

In one or more embodiments, a policy to apply to the one or more data elements that have been classified as comprising PII is predicted, wherein the predicting is performed using the one or more machine learning models.

In illustrative embodiments, interfacing with one or more cloud platforms of the plurality of cloud platforms comprises: (i) using a designated client library to upload the one or more data elements that have been classified as comprising PII to a cloud platform bucket; and (ii) using at least one of a designated API and a designated database adapter corresponding to a database of the one or more cloud platforms to download the one or more data elements that have been classified as comprising PII from the cloud platform bucket to the database.

In illustrative embodiments, interfacing with one or more cloud platforms of the plurality of cloud platforms comprises: (i) uploading the one or more data elements that have been classified as comprising PII to cloud object storage for the one or more cloud platforms; and (ii) downloading the one or more data elements that have been classified as comprising PII from the cloud object storage to a database of the one or more cloud platforms.

It is to be appreciated that the FIG. 9 process and other features and functionality described above can be adapted for use with other types of information systems configured to execute PII prediction services in a PII prediction platform or other type of platform.

The particular processing operations and other system functionality described in conjunction with the flow diagram of FIG. 9 is therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 9 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a PII prediction platform as disclosed herein can provide a number of significant advantages relative to conventional arrangements. For example, unlike conventional techniques, the embodiments provide technical solutions with functionality for managing PII data across one or more enterprises by utilizing an event driven mechanism to classify whether data elements comprise PII at the time of a request for data in a multi-cloud environment. Illustrative embodiments advantageously leverage machine learning to identify whether the data elements comprise PII, and then store the identified PII attributes in a centralized graph-based repository where the data elements and their relationships are able to be maintained and queried. For example, the PII prediction platform advantageously builds a PII data and metadata repository utilizing graphical techniques to store and manage PII data elements and their relationships with other elements and attributes for efficient traversals and query execution. The embodiments also advantageously leverage a centralized enforcement endpoint and abstraction engine for applications deployed across multiple cloud providers by using appropriate APIs, client libraries and database adapters for each cloud provider.

As an additional advantage, unlike conventional approaches, which are reactive in nature and use vast amounts of compute resources to map data at column and cell levels of database, the embodiments use a neural network-based binary classification algorithm to proactively predict as a real-time response to requests for data whether data elements constitute PII.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system components such as the PII prediction platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a PII prediction platform in illustrative embodiments. These and other cloud-based systems in illustrative embodiments can include object stores.

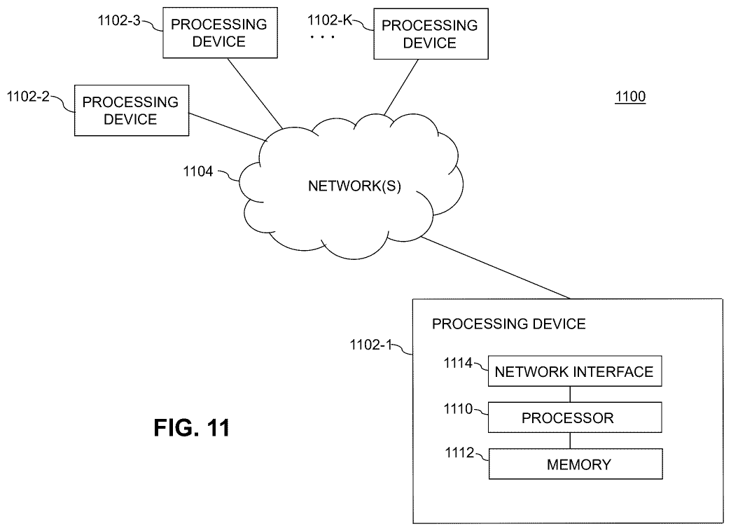

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112. The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more components of the PII prediction platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and PII prediction platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
identifying a request for data;
identifying one or more data elements that are responsive to the request for data;
analyzing the one or more data elements to classify whether the one or more data elements comprise personally identifiable information, wherein the analyzing is performed using one or more machine learning models; and
interfacing with one or more cloud platforms of a plurality of cloud platforms to transfer the one or more data elements that have been classified as comprising personally identifiable information to the one or more cloud platforms;
wherein the steps of the method are executed by a processing device operatively coupled to a memory.

2. The method of claim 1, wherein the request for data comprises one of a database request, a cache system request, an application programming interface request, a messaging system request and a streaming system request.

3. The method of claim 1, wherein the analyzing is performed in real-time responsive to the request for data.

4. The method of claim 1, wherein the one or more machine learning models comprise a neural network-based binary classification algorithm to classify whether the one or more data elements comprise personally identifiable information.

5. The method of claim 4, further comprising training a neural network of the neural network-based binary classification algorithm with training data comprising a plurality of data elements as independent variables, wherein respective ones of the plurality of data elements correspond to respective dependent variables indicating whether the respective ones of the plurality of data elements comprise personally identifiable information.

6. The method of claim 4, wherein a neural network of the neural network-based binary classification algorithm comprises at least two hidden layers utilizing a rectified linear unit activation function.

7. The method of claim 4, wherein a neural network of the neural network-based binary classification algorithm comprises a plurality of nodes connected with each other, and wherein respective ones of the connections comprise a weight factor and respective ones of the plurality of nodes comprise a bias factor.

8. The method of claim 1, further comprising storing, in one or more relationship graphs, the one or more data elements that have been classified as comprising personally identifiable information, wherein the one or more relationship graphs comprise a plurality of relationships between a plurality of nodes, wherein the plurality of relationships comprise edges of the one or more relationship graphs.

9. The method of claim 8, wherein the plurality of nodes comprise the one or more data elements that have been classified as comprising personally identifiable information and one or more other data elements.

10. The method of claim 8, wherein the plurality of relationships comprise interactions between respective pairs of the plurality of nodes.

11. The method of claim 8, wherein the one or more relationship graphs are in one of a resource description framework (RDF) format and a labeled property graph (LPG) format.

12. The method of claim 1, further comprising predicting a policy to apply to the one or more data elements that have been classified as comprising personally identifiable information, wherein the predicting is performed using the one or more machine learning models.

13. The method of claim 1, wherein interfacing with one or more cloud platforms of the plurality of cloud platforms comprises:
using a designated client library to upload the one or more data elements that have been classified as comprising personally identifiable information to a cloud platform bucket; and
using at least one of a designated application programming interface and a designated database adapter corresponding to a database of the one or more cloud platforms to download the one or more data elements that have been classified as comprising personally identifiable information from the cloud platform bucket to the database.

14. The method of claim 1, wherein interfacing with one or more cloud platforms of the plurality of cloud platforms comprises:
uploading the one or more data elements that have been classified as comprising personally identifiable information to cloud object storage for the one or more cloud platforms; and
downloading the one or more data elements that have been classified as comprising personally identifiable information from the cloud object storage to a database of the one or more cloud platforms.

15. An apparatus, comprising:
a processing device operatively coupled to a memory and configured to:
identify a request for data;
identify one or more data elements that are responsive to the request for data;
analyze the one or more data elements to classify whether the one or more data elements comprise personally identifiable information, wherein the analyzing is performed using one or more machine learning models; and
interface with one or more cloud platforms of a plurality of cloud platforms to transfer the one or more data elements that have been classified as comprising personally identifiable information to the one or more cloud platforms.

16. The apparatus of claim 15, wherein interfacing with one or more cloud platforms of the plurality of cloud platforms comprises:
using a designated client library to upload the one or more data elements that have been classified as comprising personally identifiable information to a cloud platform bucket; and
using at least one of a designated application programming interface and a designated database adapter corresponding to a database of the one or more cloud platforms to download the one or more data elements that have been classified as comprising personally identifiable information from the cloud platform bucket to the database.

17. The apparatus of claim 15, wherein interfacing with one or more cloud platforms of the plurality of cloud platforms comprises:
uploading the one or more data elements that have been classified as comprising personally identifiable information to cloud object storage for the one or more cloud platforms; and
downloading the one or more data elements that have been classified as comprising personally identifiable information from the cloud object storage to a database of the one or more cloud platforms.

18. An article of manufacture comprising a non-transitory processor-readable storage medium having stored therein program code of one or more software programs, wherein the program code when executed by at least one processing device causes said at least one processing device to perform the steps of:
identifying a request for data;
identifying one or more data elements that are responsive to the request for data;
analyzing the one or more data elements to classify whether the one or more data elements comprise personally identifiable information, wherein the analyzing is performed using one or more machine learning models; and
interfacing with one or more cloud platforms of a plurality of cloud platforms to transfer the one or more data elements that have been classified as comprising personally identifiable information to the one or more cloud platforms.

19. The article of manufacture of claim 18, wherein interfacing with one or more cloud platforms of the plurality of cloud platforms comprises:
using a designated client library to upload the one or more data elements that have been classified as comprising personally identifiable information to a cloud platform bucket; and
using at least one of a designated application programming interface and a designated database adapter corresponding to a database of the one or more cloud platforms to download the one or more data elements that have been classified as comprising personally identifiable information from the cloud platform bucket to the database.

20. The article of manufacture of claim 18 wherein interfacing with one or more cloud platforms of the plurality of cloud platforms comprises:
uploading the one or more data elements that have been classified as comprising personally identifiable information to cloud object storage for the one or more cloud platforms; and
downloading the one or more data elements that have been classified as comprising personally identifiable information from the cloud object storage to a database of the one or more cloud platforms.
